(19) United States
(12) Patent Application Publication
(10) Pub. No.: US 2010/0115863 A1
(43) Pub. Date: May 13, 2010

(54) Curtain Walling

(76) Inventor: Peter Braybrook, Gloucester (GB)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/516,732

(22) PCT Filed: Nov. 23, 2007
(86) PCT No.: PCT/GB2007/004489

§ 371 Date: May 28, 2009

(30) Foreign Application Priority Data
Nov. 29, 2006 (GB) 0623790.3

(51) Int. Cl. E06B 3/964; E04B 2/88; E06B 7/08; E04B 2/90

(52) U.S. Cl. 52/204.62; 52/235; 52/473; 52/741.1

(57) ABSTRACT

An adapter (22) for attaching a solar-shading bracket (30) to a curtain walling mullion (10), comprises a body element (24) for location on the curtain walling mullion (10) and adapted to support the solar-shading bracket (30), mullion attaching means (26) for attaching the body element (24) to the curtain walling mullion (10), and bracket attaching means (28) for attaching the solar-shading bracket (30) to the adapter (22). A method and a apparatus having an energy break device are also provided.

The present invention relates to an adapter for attaching a solar-shading bracket to a curtain walling mullion, a method of mounting a solar-shading bracket to a curtain walling mullion using such an adapter, and to apparatus for attaching solar shading to a curtain walling mullion, the apparatus including an energy break device.

In order to hang, typically exterior, solar shading across an expanse of glass, it is known from EP 1239094B1 to provide a solar-shading bracket for attachment to a curtain walling mullion. However, there are a variety of manufacturers producing curtain walling mullions with varying specifications, and yet further manufacturers producing brackets, also with varying specifications. It has therefore become increasingly difficult for a supplier to supply solar-shading brackets which fit curtain walling mullions already installed on a building, and especially where glass has been installed.

The present invention therefore seeks to provide a solution to this problem.

Furthermore, through research, it has been determined that energy transfer, both in terms of heat and sound, into and out of a building, through a curtain walling mullion, to an attached solar-shading bracket and thus into the environment is reasonably significant.

Therefore, the present invention also seeks to address this problem.

According to a first aspect of the present invention, there is provided an adapter for attaching a solar-shading bracket to a curtain walling mullion, the adapter comprising a body element for location on the curtain walling mullion and adapted to support the solar-shading bracket, mullion attaching means for attaching the body element to the curtain walling mullion, and bracket attaching means for attaching the solar-shading bracket to the adapter.

Preferable and/or optional features of the first aspect of the invention are set forth in claims 2 to 17, inclusive.

According to a second aspect of the invention, there is provided a solar-shading bracket in combination with one or more adapters for attaching a solar-shading bracket to a curtain walling mullion, the adapter comprising a body element for location on the curtain walling mullion and adapted to support the solar-shading bracket, mullion attaching means for attaching the, body element to the curtain walling mullion, and bracket attaching means for attaching the solar-shading bracket to the adapter, the solar-shading bracket having a mullion engaging formation at one end, and the body element of the adapter being shaped to receive the mullion engaging formation of the bracket.

According to a third aspect of the invention, there is provided a method of mounting a solar-shading bracket to a curtain walling mullion, the method comprising the steps of : a) providing an adapter comprising a body element adapted to support the bracket, mullion attaching means, and bracket attaching means; b) fastening the body element to the mullion using the mullion attaching means; and c) fastening the bracket to the body element using the bracket attaching means.

Preferable and/or optional features of the third aspect of the invention are set forth in claims 21 to 25, inclusive.

According to a fourth aspect of the invention, there is provided a apparatus for attaching solar shading to a curtain walling mullion, the apparatus comprising a solar-shading bracket, a curtain walling mullion to which the solar-shading bracket is attachable, and an energy break device interposed therebetween, the energy break device preventing or reducing energy transfer between the mullion and the bracket.

Preferable and/or optional features of the fourth aspect of the invention are set forth in claims 27 to 35, inclusive.

The present invention will now be more particularly described, by way of example only, with reference to the accompanying drawings, in which:

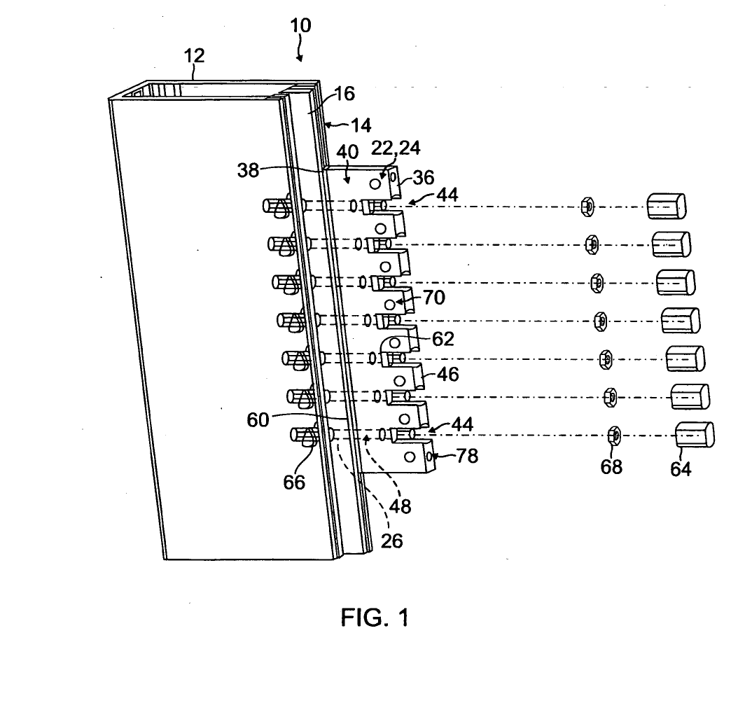

FIG. 1 shows a first embodiment of an adapter, in accordance with the first aspect of the invention, attached to a glazing bar of a curtain walling mullion, and also a first embodiment of an energy break device forming part of apparatus for attaching solar shading to a curtain walling mullion, in accordance with the fifth aspect of the invention;

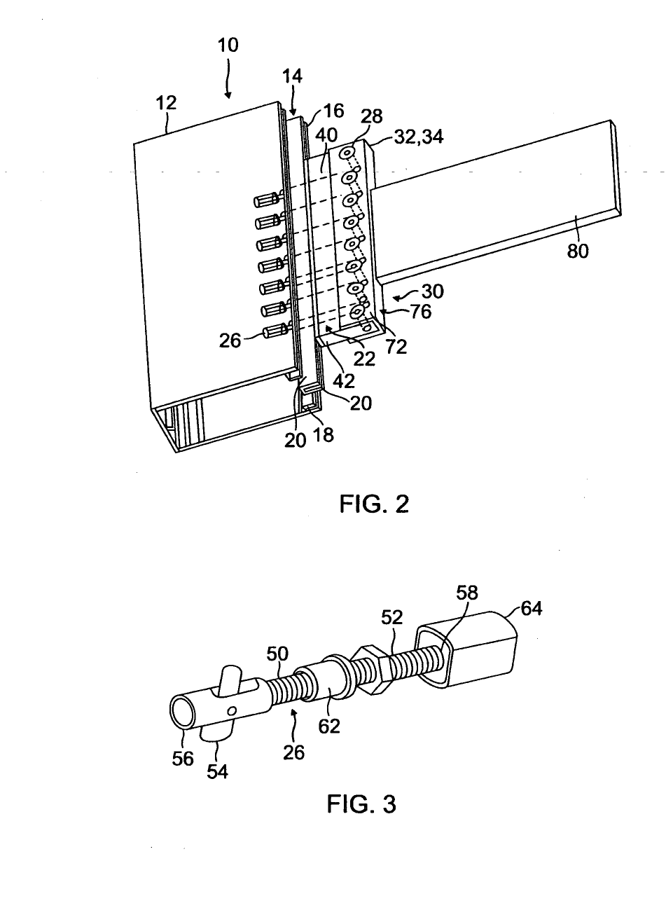

FIG. 2 shows a solar-shading bracket attached to the adapter;

FIG. 3 shows a first fastener used to connect a body element of the adapter to the mullion;

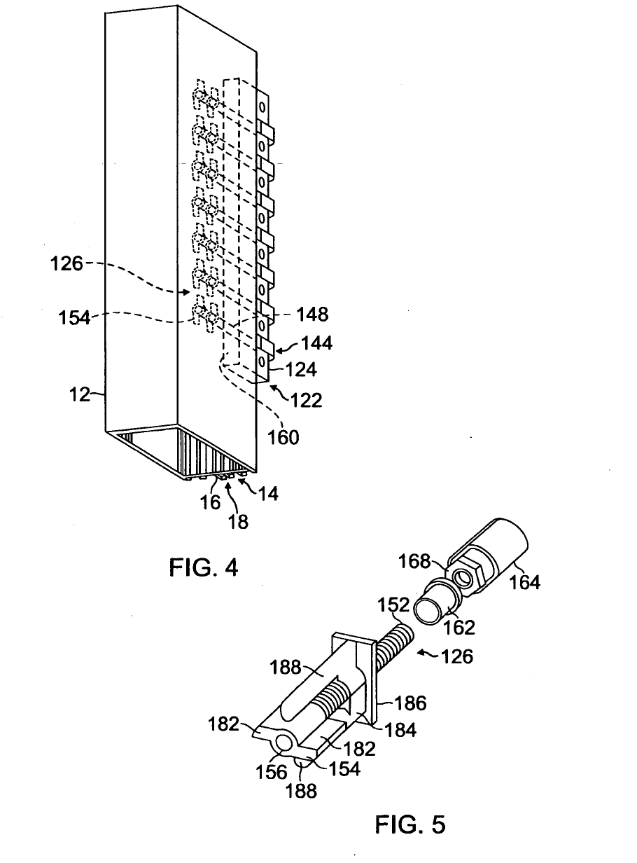

FIG. 4 shows a second embodiment of an adapter, in accordance with the first aspect of the invention, attached to a glazing bar of a curtain walling mullion, and having a modified first fastener used to connect the body element of the adapter to the mullion;

FIG. 5 shows a perspective view of the modified first fastener shown in FIG. 4;

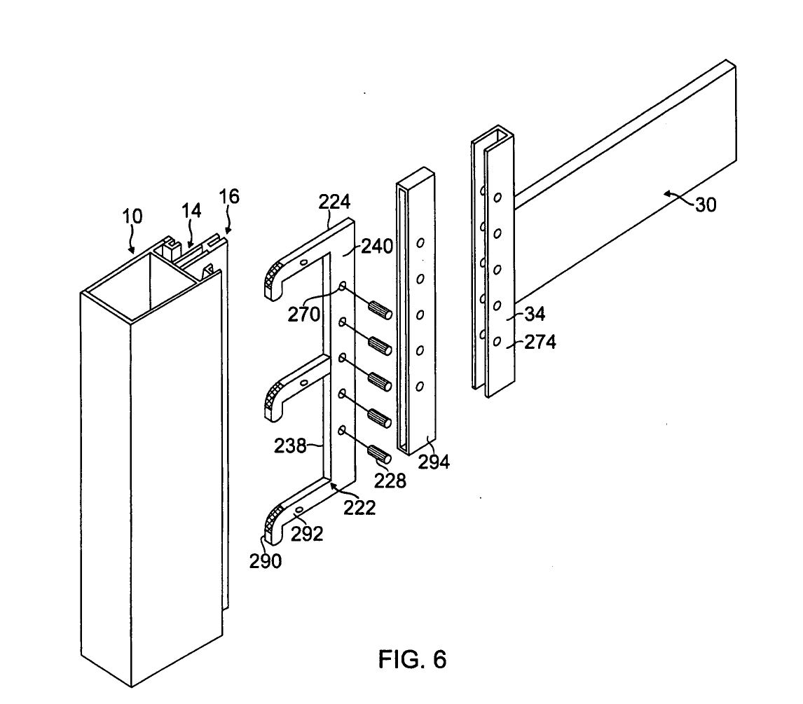

FIG. 6 shows a third embodiment of an adapter, in accordance with the first aspect of the invention, in exploded fashion relative to a glazing bar of a curtain walling mullion;

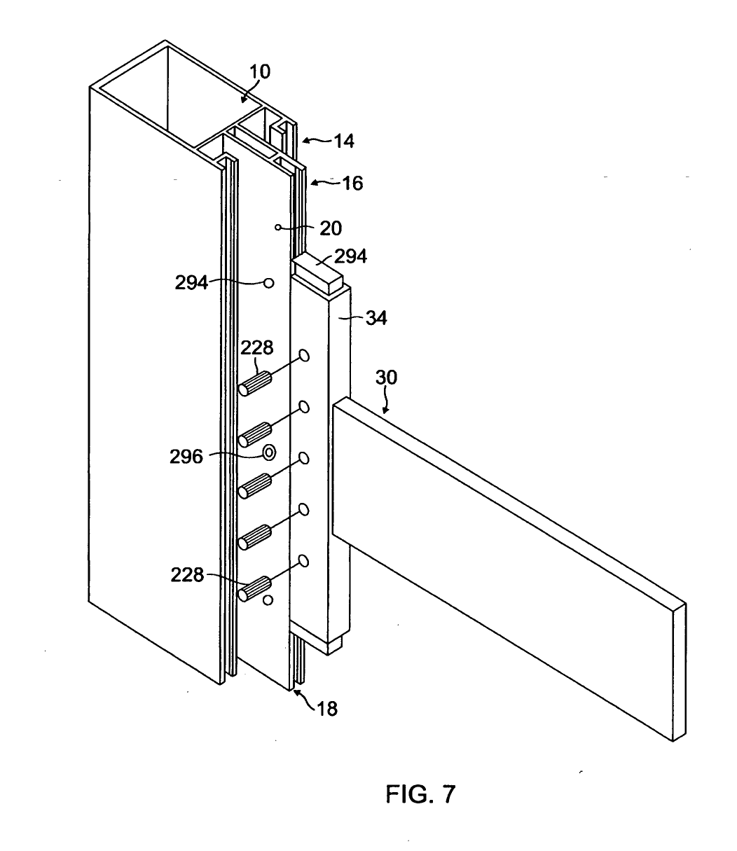

FIG. 7 shows the mullion, third embodiment of the adapter, energy break device, and solar-shading bracket, when assembled;

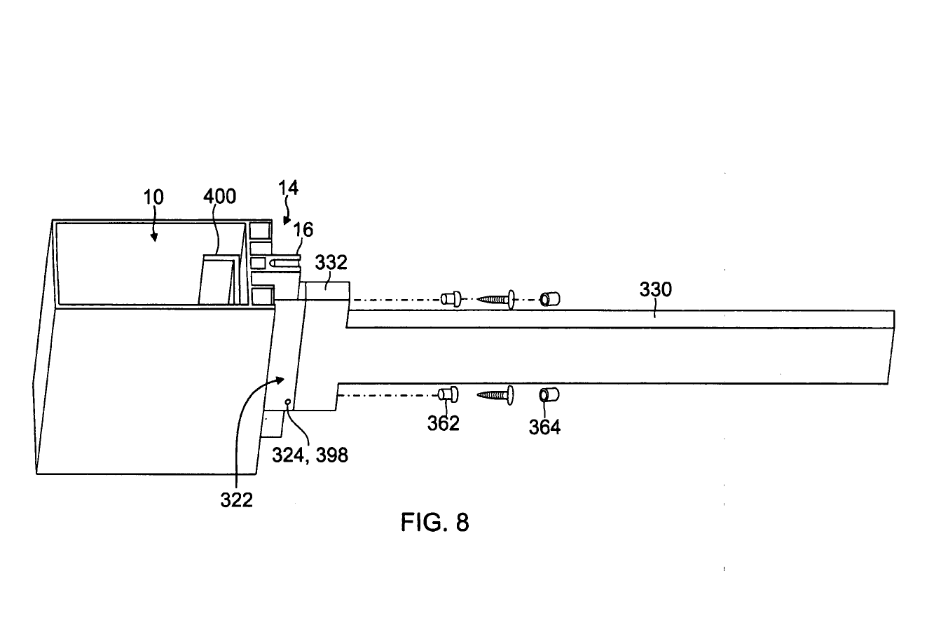

FIG. 8 shows a fourth embodiment of an adapter, in accordance with the first aspect of the invention and interposed between a curtain walling mullion and a solar-shading bracket;

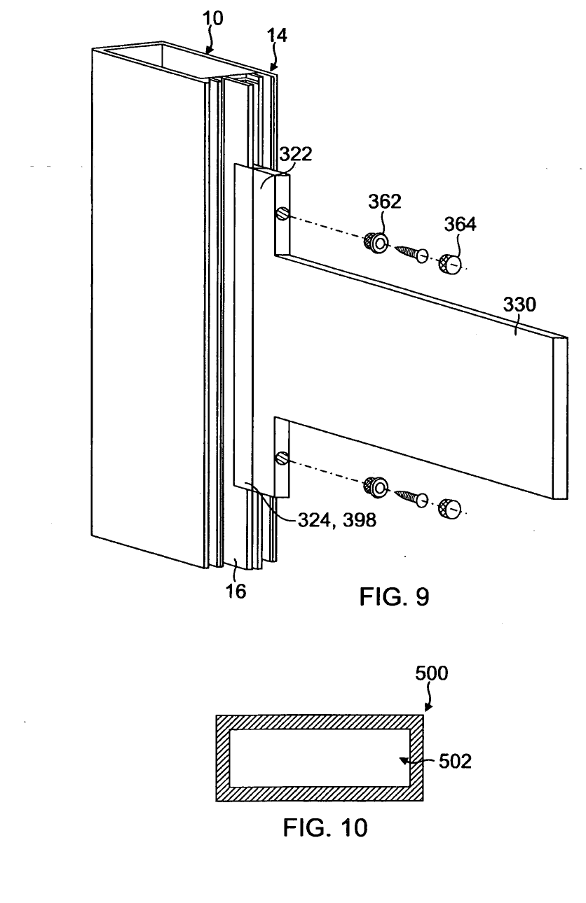

FIG. 9 is a view of the adapter shown in FIG. 8, from another direction;

FIG. 10 is a diagrammatic cross-sectional view of a second embodiment of an energy break device, in accordance with the fifth aspect of the invention;

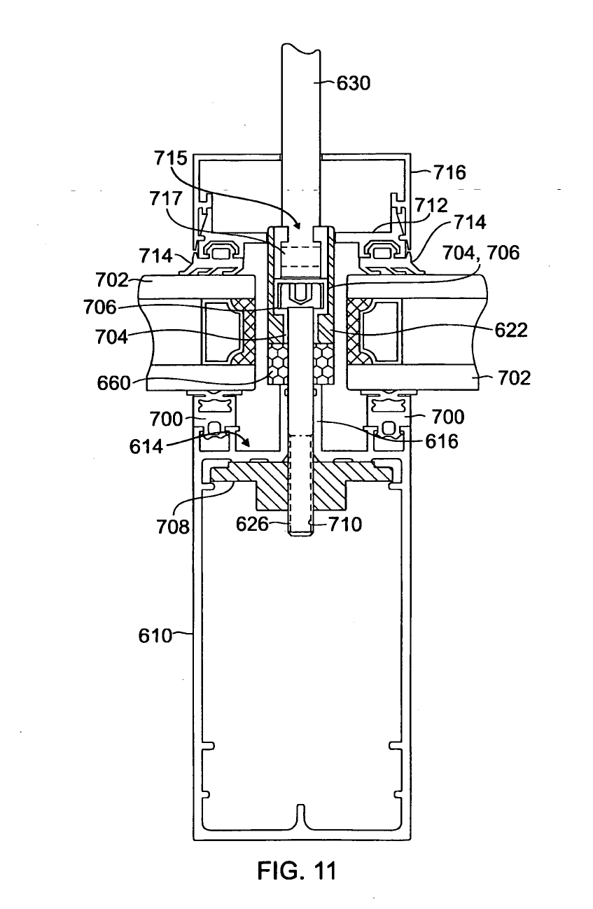

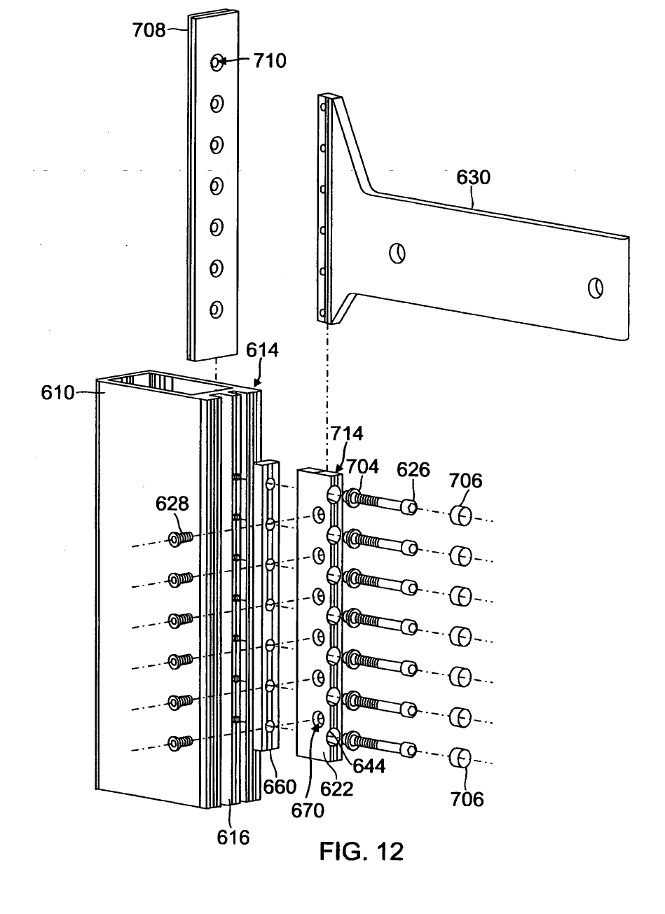

FIG. 11 shows a cross-sectional view of a fifth embodiment of an adapter, in accordance with the first aspect of the invention, mounted to a curtain walling mullion via an energy break device, glazing units, a pressure plate, and with a solar-shading bracket attached to the adapter;

FIG. 12 shows a perspective exploded view of the fifth embodiment, with the glazing units and pressure plate removed for clarity; and

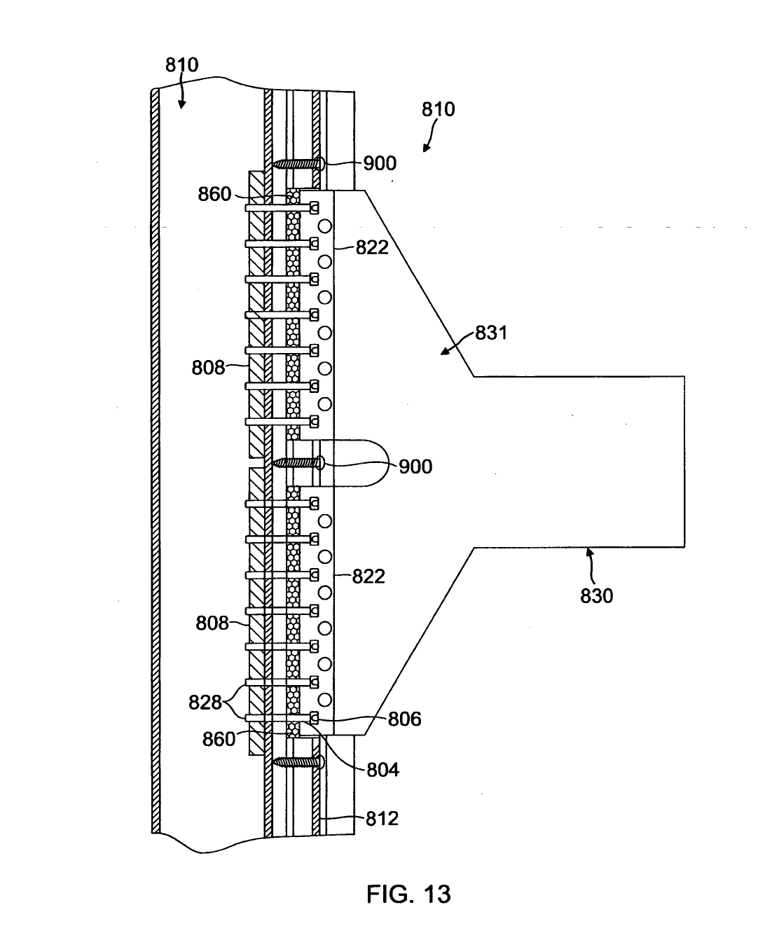

FIG. 13 shows a diagrammatic side view of a sixth embodiment of a curtain walling mullion with two adaptors supporting a single solar-shading bracket.

Referring firstly to FIGS. 1 to 3 of the drawings, there is shown a known curtain walling mullion 10 which comprises a box-section mullion 12 having an integral glazing bar 14 extending along a length of an in use front face of the mullion. The mullion is typically extruded in aluminium.

The glazing bar 14 has a stem portion 16 which projects forwardly from, and which extends centrally or substantially central along, the front face of the mullion 12.

The stem portion 16 has a U-shaped or substantially U-shaped lateral cross-section, thus defining an open channel 18. Opposing side walls 20 of the channel 18 are typically serrated to receive self-tapping screws during installation of glazing assemblies on the glazing bar 14.

An adapter 22 is shown in FIGS. 1 and 2, attached to the stem portion 16 of the glazing bar 14. The adapter 22 comprises an elongate, typically metal or insulating plastics or rubber, body element 24 which is positionable directly on the stem portion 16 of the glazing bar 14, mullion attaching means which includes first fasteners 26 for fastening the body element 24 to the glazing bar 14 and/or box-section mullion 12 itself, bracket attaching means which includes second fasteners 28 for attaching a solar-shading bracket 30 to the body element 24, and energy break means for preventing or reducing thermal and/or acoustic energy transfer between the mullion 12 and a solar-shading bracket 30.

The body element 24 has a width which matches or substantially matches an exterior width of the stem portion 16, so that the body element 24 can be seated on and supported by the walls 20 of the channel 18 of the stem portion 16. The body element 24 also has a length which matches or substantially matches a mullion contacting portion 32, generally being a U-shaped saddle portion 34, of the solar-shading bracket 30 (see FIG. 2). The U-shaped saddle portion 34 of the bracket 30 is shaped to, typically, complementarily receive or engage the stem portion 16 of the glazing bar 14 therein.

The body element 24 is generally cuboid shaped, and has a front bracket-facing surface 36, a rear mullion-facing surface 38, two major side surfaces 40 contiguous with the front and rear surfaces 36, 38, and two minor end surfaces 42 contiguous with the front, rear and side surfaces 36, 38, 40. The major side surfaces 40 have longitudinal extents which are significantly greater than lateral dimensions of the minor end surfaces 42.

As part of the mullion attaching means, the front surface 36 includes a plurality of equi-distantly spaced recesses 44 along the entire longitudinal extent of the body element which thus aids bearing capacity. In this embodiment, the recesses 44 break out onto the major side surfaces 40. However, the recesses can be formed to be enclosed.

The break out of the recesses 44 results in castellations 46 or a tooth-like profile being formed along the body element 24.

A through-hole 48 is formed in the base of each recess 44 to extend to and break out from the rear surface 38 of the body element 24. The recesses 44 and the through-holes 48 are dimensioned to receive as a close-fit the first fasteners 26 of the mullion attaching means.

As shown in FIG. 3, the first fasteners 26 have an elongate shank 50, at least threaded at a head-end 52, and a pivotable catch element 54 at or adjacent to a tail-end 56. A face 58 of the shank 50 at the head-end 52 preferably includes a slot (not shown) to receive a screw-driver or similar tool. The pivotable catch element 54 has a pivot axis which extends laterally to the longitudinal extent of the shank 50. The pivotable catch element 54 is asymmetric about the pivot axis, resulting in the pivotable catch element 54 having the tendency to pivot to a position in which a longitudinal extent of the catch element 54 is normal to the longitudinal extent of the shank 50.

The energy break means comprises a plurality of energy break devices, including an insulating sheet 60 for interposition between the rear mullion-facing surface 38 of the body element 24 and the stem portion 16 of the glazing bar 14, an insulating flanged sleeve 62 for location on the base of each recess 44 and which projects into the through-hole 48, and an insulating cap 64 for positioning in the recess 44 to cover the head-end 52 of the first fastener 26.

The tail-end 56 and/or the pivotable catch element 54 of the first fasteners 26 is/are also, preferably, formed of or covered in insulating material, thus also forming part of the energy break means.

To attach the body element 24 of the adapter 22 to the stem portion 16 of the glazing bar 14, through-holes 66 of sufficient dimension to receive the tail-end 56 of the first fasteners 26 are first formed, typically by an installer using a drill, in the base of the channel 18 of the stem portion 16 and into the box-section mullion 12. The body element 24 is placed on the edges of the stem portion 16, with the insulating sheet 60 therebetween. The first fasteners 26 are slid into the respective recesses 44 in the body element 24, into the insulating flanged sleeves 62, and through the through-holes 48, 66, until the tail-ends 56 project into the interior of the box-section mullion 12. Once free of the constraints of the through-holes 66, the pivotable catch elements 54 pivot and abut against an interior surface of the box-section mullion 12, thus preventing the first fasteners 26 from being withdrawn. A mating threaded nut 68 is then wound onto the head-end 52 of the shank 50. The nut 68 is wound down into the recess 44 until it abuts against the insulating flanged sleeve 62 on the base of the recess 44. The body element 24 is thus securely clamped to the stem portion 16, and the insulating caps 64 are pressed into the recesses 44.

The first fasteners 26 described above are obviously beneficial, since they provide far greater load bearing capacity for the solar-shading bracket 30. However, other kinds of fasteners can be utilised, for example, self-tapping screws. In this case, through-holes 66 which extend between the base of the stem portion 16 and the interior of the box-section mullion 12 could be dispensed with, and the self-tapping screws can simply engage with the side walls 20 of the channel 18 of the stem portion 16.

As part of the bracket attaching means, a plurality of lateral through-openings 70 are formed through the major side surfaces 40 of the body element 24. The through-openings 70 are dimensioned to closely receive the second fasteners 28 of the bracket attaching means. The mullion attaching means and the bracket attaching means thus in use extend transversely, and typically laterally, to each other.

To attach the solar-shading bracket 30 to the installed adapter 22, the U-shaped saddle portion 34 is simply seated on the body element 24. Side walls 72 of the U-shaped saddle portion 34 of the bracket 30 are typically preformed with holes which match the through-openings 70 formed in the body element 24 of the adapter 22. The second fasteners 28 are thus slid through the holes in the side walls 72 of the saddle portion 34 of the bracket 30, and through the though-openings 70 in the body element 24, thereby engaging the bracket 30 with the adapter 22.

The glazing bar 14 typically has insulating rubber strips which run in spaced parallel relationship with the stem portion 16. The panes of glass abut the insulating strips, and a pressure plate is then used to clamp the panes of glass in place. The pressure plate is connected to the stem portion 16 by threaded fasteners. The pressure plate also includes similar insulating rubber strips which oppose those on the glazing bar 14. Thus, each pane of glass is sandwiched tightly between the glazing bar and the pressure plate. This is common practice and well known in the field.

In the present invention, the adapter 22 is installed on the glazing bar side of the pressure plate, on the solar-shading bracket side of the pressure plate, or passing though the pressure plate. In the latter case, the pressure plate is formed with a suitably dimensioned opening which will accept the adapter 22.

The second fasteners 28 can be, for example, screw-threaded devices, such as nuts and bolts, or even self-tapping screws.

Some known solar-shading brackets have openings (not shown) in a web portion 76 which extends between the side walls 72 of the U-shaped saddle portion 34, instead of the above-described openings which extend in a lateral direction to the direction of projection of the in use bracket 30. The web portion 76 defines a base of the U-shaped saddle portion 34, and these openings thus extend in parallel with the direction of projection of the in use bracket 30.

A solar-shading bracket having such openings is thus traditionally engaged with the glazing bar 14 simply by locating screws or bolts in the openings and fastening in the channel 18 of the stem portion 16.

To provide for this alternative method of attachment of the bracket, the bracket attaching means of the body element 24 of the adapter 22 includes end-openings 78 formed in the front surface 36, adjacent to the minor end surfaces 42. The end-openings 78 are though-holes, suitable for receiving self-tapping screws or nuts and bolts. In this regard, the bracket attaching means thus extends in parallel or substantially parallel with the mullion attaching means.

The energy break means described above can also be applied to the bracket attaching means.

The adapter 22 can be provided with only the lateral through-openings 70, only the end-openings 78, or both.

With the adapter 22 attached to the glazing bar 14, and the solar-shading bracket 30 attached to the adapter 22, solar shading can thus be hung, in any suitable known manner, from an, typically planar, arm portion 80 which extends forwardly from the U-shaped saddle portion 34.

Referring now to FIGS. 4 and 5 of the drawings, a second embodiment of an adapter 122 is shown. This adapter 122 is similar to that of the first embodiment, except for a first fastener 126 of the mullion attaching means. These first fasteners 126 have improved loading bearing characteristics over those described above, and also form part of adjustment means which allows for adjustment of a body element 124 relative to the first fasteners 126.

The box-section mullion 12 and glazing bar 14 with central or substantially central stem portion 16 are as described above, and the same references are used. Consequently, further detailed description is omitted.

The first fastener 126 includes an, at least partially screw-threaded, elongate shank 150, a head-end 152 having a slot in an adjacent end face for receiving a screw-driver or other similar tool, and a tail-end 156 having a movable catch element 154 engaged thereon. The catch element 154 is angularly displaceable about the longitudinal extent of the shank 150 by rotation of the shank 150, and includes two elongate offset arm members 182 which extend generally radially outwardly and in generally opposite but offset directions from each other.

The first fastener 126 also includes a bearing element 184 which is threadingly engaged on the shank 150. The bearing element 184 includes a bearing portion 186 intermediate the head-end 152 and the tail-end 156, and two offset prong elements 188 which extend in parallel or substantially parallel spaced relationship along opposite sides of the shank 150. The two prong elements 188 extend to a plane which is normal to the longitudinal extent of the shank 150 and in which the catch element 154 lies.

Energy break means are again utilised for preventing or limiting the transfer of thermal and/or acoustic energy between the body element 124 and the box-section mullion 12. The energy break means comprises an insulating flanged sleeve 162 and an insulating cap 164 as described above. Furthermore, the movable catch element 154 and the bearing element 184 are formed from insulating, typically plastics, material.

The first fastener 126 of the second embodiment is used in a similar manner to the first fastener 26 of the first embodiment. However, the recesses 144 and through-holes 148 of the mullion attaching means through the body element 124 are dimensioned to receive the catch element 154 and the prong elements 188. In a first condition in which the offset arm members 182 of the catch element 154 lie against a first portion of the offset prong elements 188, a compact oval or other non-circular lateral cross-sectional shape is formed. In a second condition in which the catch element 154 is angularly displaced so that the arm members 182 lie against a second portion of the offset prong element, opposite the first portion, due to the arm members 182 and the prong elements 188 being offset, an enlarged oval or non-circular lateral cross-sectional shape results.

The recesses 144 and the through-holes 148 of the mullion attaching means are thus shaped to substantially match the compact oval or other non-circular shape, thereby allowing passage of catch element 154 and prong elements 188 when in the first condition.

In a similar fashion, the through-holes 66 (see FIG. 1) formed in the base of the channel 18 of the stem portion 16 and through into the interior of the box-section mullion 12 match or substantially match those formed in the body element 124. As before, the body element 124 is placed on the edges of the stem portion 16 with the insulating sheet 160 therebetween, and, with the catch element 154 and the prong elements 188 adopting the first compact condition, the first fasteners 126 are slid into the respective non-circular recesses 144 in the body element 124, and through the non-circular through-holes 66, until the tail-ends 156, including the catch element 154 and end portions of the prong elements 188, project into the interior of the box-section mullion 12. The bearing portion 186 of the bearing element 184 is received in the recess 144 in the body element 124, and abuts against the base of the recess 144 without passing into the through-hole 148. By then turning the shank 150, the catch element 154 rotates to adopt the second enlarged condition, causing the catch element 154 to overlap the through-hole 66 in the box-section mullion 12.

By rotating the shank 150, the catch element 154 is wound along the shank 150 until, due to the overlap, it contacts the interior surface of the box-section mullion 12. The body element 124 is thus clamped to the stem portion 16 of the glazing bar 14 via the bearing portion 186 of the bearing element 184 and the arm members 182 of the catch element 154.

A nut 168 is typically threaded onto the head-end 152 to prevent loosening, and the insulating cap 164 is pressed into the recess 144.

Due to the non-circular recesses 144 and through-holes 148, 66, adapter 122 is provided with adjustment means. The shank 150 of the first fastener 126 has a, typically circular, lateral cross-section which has a dimension smaller than that of the non-circular recesses 144 and through-holes 148 formed in the body element 124. As such, limited movement of the shank 150 of the first fastener 126, in a direction normal to the longitudinal extent of the shank 150, relative to the body element 124 is possible. This is extremely advantageous, since it dispenses with the need for particularly accurate alignment tolerances when the installer is forming the through-holes 66 in the stem portion 16 of the glazing bar 14 and into the interior of the box-section mullion 12.

Referring now to FIGS. 6 and 7, there is shown a third embodiment of an adapter 222 for mounting a solar glazing bracket 30 to an extruded, typically aluminium, glazing bar 14 of a curtain walling mullion 10.

The mullion 10, glazing bar 14, and solar-shading bracket 30 are as described in the first embodiment. Consequently, identical references are used for identical parts, and further detailed description is omitted.

The adapter 222 in this embodiment comprises an elongate, typically metal, body element 224 which is positionable directly on or in the stem portion 16 of the glazing bar 14, mullion attaching means, bracket attaching means, and energy break means.

The mullion attaching means includes a plurality of hooks 290, being in this case three. The hooks 290 project from a rear mullion-facing surface 238 of the body element 224, and are integrally formed as part of the body element 224. However, the hooks can be formed as discrete elements and attached to the body element. The hooks are fasteners.

The recesses and through-holes of the mullion attaching means of the first and second embodiments, which are formed in the body element, are thus dispensed with. However, they can be provided in addition to the hooks 290, in order to provide an installer with further installation options.

The mullion attaching means also includes through-holes 292 formed laterally through each hook 290, which correspond to through-openings 294 formed in side walls 20 of the stem portion 16.

The bracket attaching means is as described with reference to the first embodiment of the adapter. As such, a plurality of lateral through-openings 270 are formed through major side surfaces 240 of the body element 224 at positions which align with the holes 274 formed in the side walls of the U-shaped saddle portion 34 of the solar-shading bracket 30. The through-openings 270 in the body element 224 are dimensioned to closely receive second fasteners 228 of the bracket attaching means.

The energy break means includes an insulating cover 294 which is positionable over the body element 224. The insulating cover 294 has a generally U-shaped lateral cross-section.

To attach the body element 224 of the adapter 222 to the stem portion 16 of the glazing bar 14, slots (not shown) of sufficient dimension to receive the hooks 290 are first formed in spaced relationship in the base of the channel 18 of the stem portion 16 and, typically, into the interior of the box-section mullion 12. The body element 224 is placed on to the edges of the stem portion 16, such that the hooks 290 engage in the slots. Third fasteners 296 are then inserted transversely through the through-openings 294 of the stem portion 16 and the through-holes 292 of the hooks 290 to securely retain the body element 224 in place.

The solar-shading bracket 30 is attached in the manner described above. The insulating cover 294 is placed on the body element 224, and the U-shaped saddle portion 34 of the bracket 30 is seated directly on the insulating cover 294. The second fasteners 228 are used to engage the bracket 30 with the body element 224 such that the insulating cover 294 is interposed therebetween.

To further limit undesirable transfer of thermal and/or acoustic energy, the first, second and/or third fasteners described above can be formed from, or include, insulating material, thus forming part of the energy break means.

Referring to FIG. 8, a third embodiment of an adapter 322 is shown. Again, the mullion 10 and glazing bar 14 are as described above, and thus identical references are used to refer to identical parts. The solar-shading bracket 330 is similar to that described above, except that the mullion contacting portion 332, instead of being a U-shaped saddle, is a solid mounting portion. This solar-shading bracket 330 is another known bracket, similar to that described above, and the two known solar-shading brackets can be interchanged for use with the adapters of the invention.

The adapter 322 comprises an elongate body element 324, mullion attaching means, bracket attaching means, and energy break means. The mullion attaching means and the bracket attaching means can utilise any of the methods or devices mentioned above, and thus further description is omitted.

The body element 324 can be formed from any suitable material, including metal. However, preferably, the body element 324 is formed of insulating material, thus being an energy break device and forming part of the energy break means.

The body element 324 of this embodiment is formed with a generally U-shaped saddle portion 398 in which the stem portion 16 of the glazing bar 14 is received. The saddle portion 398 extends the length of the body element 324.

In order to promote stability of the adapter 322, the saddle portion 398 can optionally have a front-to-back depth which allows contact with surfaces of the glazing bar 14 adjacent to the stem portion 16.

The bracket attaching means can include the mullion attaching means, thus allowing one set of fasteners to be used to both attach the bracket 330 to the body element 324 and to attach the body element 324 to the stem portion 16 of the glazing bar 14. However, for ease of installation, it is preferable that the mullion attaching means and the bracket attaching means are separate.

The mullion attaching means also includes a discrete reinforcing element 400 which is provided in the interior of the box-section mullion 12 during installation. The reinforcing element 400 is a generally U-shaped channel which helps to spread load applied the solar-shading bracket 330.

The other energy break devices forming the energy break means are similar to those described above, and include at least insulating sleeves 362 and insulating caps 364, as shown in FIGS. 8 and 9.

The energy break means described above can utilise any insulating device formed from appropriate insulating material for spacing apart the body element and the curtain walling mullion, the mullion attaching means and the curtain walling mullion, the bracket attaching means and the body element, and/or the body element and the solar-shading bracket.

Although it is preferable that the energy break means fully or substantially fully isolates the curtain walling mullion from all attachments thereto, being for example the adapter and the solar-shading bracket, along with any and all fasteners, isolation from some, but not all, of the attachments will provide energy saving benefits.

The insulation material used to form the devices comprising the energy break means is preferably plastics, for example rubber, silicon, polymide, and EPDM having a suitable Shore hardness in relation to compressability.

Referring to FIG. 10, a modification to the energy break devices (generally referenced as 500) described above and forming the energy break means is shown. In this embodiment, one or more of the devices 500, such as the insulating sheet, includes a sealed chamber 502. The sealed chamber 502 has a vacuum therein, or is alternatively filled with an insulating gas, such as an inert gas, for example Argon.

In a further embodiment shown in FIGS. 11 and 12, the mullion 610 with glazing bar 614, typically integrally extruded together, support elongate insulating strips 700. A pane of glass 702 bears against each insulating strip 700, either side of the central stem portion 616 of the glazing bar 614.

An insulating sheet or strip 660 is interposed between the adapter 622 and the front edges of the central stem portion 616. As above, the insulating sheet or strip is formed of an insulating material, such as plastics, for example, nylon, or rubber.

The adapter 622 is connected to the mullion by the mullion attaching means, which in this case includes a plurality of screw-threaded fasteners 626 which are recessed into the adapter 622 and insulated therefrom by the use of insulating bushes or sleeves 704 and caps 706. Again, the sleeves and caps are typically formed from plastics or rubber.

As in the third embodiment, a discrete reinforcing element or spreader plate 708 is received within the mullion 610. The spreader plate 708 includes screw-threaded apertures 710 to receive the fasteners 626.

To hold the panes of glass in place 702 in place, a pressure plate 712 with further insulating strips 714 is fastened either directly to the central stem portion 616 of the glazing bar 614 and/or to the adapter 622. The panes of glass 702 are thus securely sandwiched between the glazing bar 614 and the pressure plate 712.

The solar-shading bracket 630 is attached as described above. In other words, the bracket attaching means, for example being screw-threaded fasteners 628, is preferably separate of the mullion attachment means. Consequently, the load imparted to the bracket by the solar shading can be better spread due to the use of more fasteners 628 than would otherwise be possible if attaching the bracket to the adapter using the same fasteners 626.

As best seen in FIG. 12, the adapter 622 has a U-shaped lateral cross-section or channel 714 running along its longitudinal extent. Recessed apertures 644 are formed to receive the first fasteners 626, forming part of the mullion attaching means, as well as the insulating bushes 704. The insulating sheet or strip 660 is interposed between the adapter 622 and the central stem portion 616.

The spreader plate 708 screw-threadingly engages the first fasteners 626. The insulating caps 706 are pressed into the recessed apertures 644 to cover the heads of the fasteners 626.

The solar-shading bracket 630 is slid into the channel 714. A keyway 715 is defined in the channel 714 along its longitudinal extent and the bracket 630 includes a keying formation 717 including a waisted or necked portion extending therealong adjacent to one edge. The keying formation 717 keys or engages in the channel, only allowing the bracket 630 to be slid in a longitudinal direction out of an end of the channel and thus out of engagement.

Extending laterally to the recessed apertures 644, through-openings 670 are formed in alternating fashion with the recessed apertures 644. As in the first embodiment, the bracket 630 includes lateral holes which are alignable with the through-openings 670, thus allowing insertion of the second fasteners 628.

The keying is important, since it spreads the load applied by the in use bracket. Consequently, the second fasteners take a reduced load and thus assume more of a locating role for holding the bracket in place, rather than a primary load bearing role.

The pressure plate 712 is then connected either separately to the adapter 622 or directly to the glazing bar 614 via further screw-threaded fasteners.

Any further capping plate 716 to provide a neat external appearance and to cover the recessed apertures 644 can then be applied.

This preferred embodiment can of course be modified by features of the above described embodiments.

FIG. 13 shows a curtain walling mullion system 810, similar in arrangement to those described in the preceding embodiments. However, in this arrangement, two adapters 822 with insulating energy break devices, being the sheet or strip 860, bushes 804 and caps 806, are utilised in order to support a much larger solar-shading bracket 830. The adaptors 822 are longitudinally aligned and fastened to the mullion again via the mullion attachment means, in this case including the first fasteners 828 and the spreader plates 808.

Although in this embodiment, the adapters 822 pass through the pressure plate 812 of the mullion system 810, which holds the panes of glass of the glazing units in place, the adaptors can sit on the outside of the pressure plate with the fasteners passing through the pressure plate and engaging the spreader plates 808 within the mullion.

It is of course also feasible that the adapters could sit on the inside of the pressure plate, instead, such that the pressure plate is interposed between the solar-shading bracket and the adaptors.

Conveniently, the adaptors are dimensioned to be interposable between fasteners of the pressure plate. In this embodiment, the fasteners 900 of the pressure plate are spaced by around 250 mm, and the adaptors have a longitudinal extent which is 210 mm. By providing a solar-shading bracket 830 with two legs 831, one of the pressure plate fasteners 900 can be spanned or bridged.

This arrangement is advantageous, since the standard centres of the pressure plate fasteners do not have to be altered to fit around the adapters. Furthermore, the correct pressure is maintained by the pressure plate holding the glazing units in place, which is critical.

The energy break means has been shown, through research, to reduce thermal energy transfer between the curtain walling mullion and the solar-shading bracket. The energy break means has also been shown to reduce acoustic energy transfer between the curtain walling mullion and the solar-shading bracket.

It will be readily appreciated, that the adapter described above can be used without the energy break means, and that, with regards to the adapter, although beneficial, it is entirely optional as to whether the energy break means is utilised.

It will also be readily understood, that the energy break means can be used without the adapter. In this case, the energy break means is simply interposed between a known solar-shading bracket and a known curtain walling mullion. In this case, the bracket attaching means, typically supplied with the solar-shading bracket, can be utilised. The fitting of the energy break means can be undertaken either at the time of installation, or as a retro-fit to a previously installed solar-shading bracket.

Although the adapter is intended to be engaged with a stem portion of a glazing bar, the stem portion can be dispensed with in favour of only using the adapter.

Although typically a solar-shading bracket is provided to which a solar-shading arm supporting the solar-shading louvers is connected, the arm could be directly connected to the adapter, and thus the arm in this case can be considered to be the bracket.

The adapter thus provides a universal interface between glazing bars and solar-shading brackets provided by different manufacturers. The adapter is simple to manufacture and cost-effective. The adapter allows a supplier to supply any curtain walling mullion and/or any solar-shading bracket, also known as a brise soleil bracket, in the knowledge that the adapter can be utilised as an interface between the two parts.

It is also possible to significantly improve the energy efficiency associated with the installation of solar shading, by the use of an energy break device, whilst also preventing interstitial condensation in the mullion. The energy break device can be used in conjunction with, or independently of, the adapter. The Centre For Window Cladding And Technology (CWCT Services Ltd), of University of Bath, Bath, BA2 7AY, United Kingdom, was commissioned to perform an independent study regarding the improvement in energy efficiency through use of the energy break device, and in particular when using the insulating sheet or strip, insulating sleeves and insulating caps. The result of the study was extremely positive, showing a significant reduction in thermal energy transfer. The conclusion of the report states:
‘The thermally broken brise soleil bracket has a much improved thermal performance compared to conventional aluminium brise soleil bracket when inserted into a Technal MX mullion.
The point thermal transmittance represents the extra heat loss due to the cold bridge induced by the bracket. The pure improvement percentage of the bracket without taking into account of the influence of the glazing unit is 70.43 per cent and the improvement percentage of the bracket is 67.61 per cent when a 6/16/6 air filled DGU with soft low-E coating is used.
Furthermore, the thermally broken bracket also increases the minimum internal surface temperature of the back box by 6.4° C. when the above DGU is used, the minimum internal surface temperature at the edge of the glazing by 1.1° C.

Although the fixing bolts penetrate the back box, there is no interstitial condensation risk at Surface A—the surface between the spreader plate and the back box providing that the mullion is well-sealed at the joints.’

By using only parts of the energy break means or energy break device, for example the insulating sheet, or the bushes, or the caps, a reduction in thermal energy transfer will also be realised, although not as great as when using all parts of the energy break means together.

A further independent study was also commissioned from Industrial Commercial and Technical Consultants of 29a Ashburton Road, Croydon, CR0 6AQ, Surrey, United Kingdom regarding the improvement in energy efficiency through use of the energy break device, and in particular when using the insulating sheet or strip, insulating sleeves and insulating caps. The result of the study was extremely positive, showing a significant reduction in acoustic energy transfer. The conclusion of the report states :
‘the inclusion of the isolation material in the bracket design offers approximately 95% isolation for the frequency band 2000 Hz to 5500 Hz.
Isolation takes effect from around a frequency of 700 Hz onwards.
This range of frequencies covers the range of frequencies that can be excited in louvers and associated structural components, the bracket therefore reduces the risk of induced audible sound levels being transmitted to building structure.’

It is known in the field that specialist and expensive independent acoustic isolation equipment, located within the building, generally achieves around 90% acoustic isolation, with 95% being the preferred target. The present invention thus achieves the preferred target by a simple and cost-effective energy break device or energy break means incorporated during attachment of the solar shading, or as a retrofit.

The embodiments described above are given by way of examples only, and various other modifications will be apparent to persons skilled in the art without departing from the scope of the invention, as defined by the appended claims. For example, instead of a plurality of hooks, a single hook can be provided by which the body element is engageable with the curtain walling mullion.

1-35. (canceled)

36. An adapter for attaching a solar-shading bracket to a curtain walling mullion, the adapter comprising:
a body element for location on the curtain walling mullion and adapted to support the solar-shading bracket;
an attachment for attaching the solar-shading bracket to the curtain walling mullion; and
an energy break device to provide heat insulation between the solar-shading bracket and the curtain walling mullion as well as between the solar attachment and the curtain walling mullion.

37. An adapter according to claim 36, wherein the attachment comprises a mullion attachment for attaching the body element of the adapter to the curtain walling mullion and a bracket attachment for attaching the solar-shading bracket to the body element of the adapter.

38. An adapter according to claim 37, wherein the energy break device comprises a first insulator for provision between the body element and the curtain walling mullion and a second insulator for provision between the body element and the mullion attachment.

39. An adapter according to claim 38, wherein the mullion attachment comprises a set of first fasteners for positioning through a set of corresponding first through-holes provided in the body element substantially perpendicularly with respect to a longitudinal extent of the curtain walling mullion.

40. An adapter according to claim 39, wherein the bracket attachment comprises a set of second fasteners for positioning through a set of corresponding second through-holes provided in the body element, the first and second through-holes being substantially perpendicular with respect to one another.

41. An adapter according to claim 40, wherein the second insulator further includes an insulating sleeve for each fastener of the set of second fasteners.

42. An adapter according to claim 37, wherein the energy break device comprises a first insulator for provision between the body element and the solar-shading bracket and a second insulator for provision between the body element and the bracket attachment.

43. An adapter according to claim 42, wherein the bracket attachment is of an insulating material thereby forming the second insulator.

44. An adapter according to claim 42, wherein the mullion attachment comprises hook formations for engaging the curtain walling mullion.

45. An adapter according to claim 36, wherein the energy break device comprises a first insulator for provision between the body element and the curtain walling mullion and the attachment is configured for securing the solar-shading bracket to the curtain walling mullion via the body element, wherein the attachment comprises a second insulator for provision between the attachment and body element, the first and the second insulators providing the energy break device.

46. An adapter according to claim 36, wherein the body element is formed of a first insulator and the attachment is configured for securing the solar-shading bracket to the curtain walling mullion via the body element, wherein the attachment comprises a second insulator for provision between the attachment and body element, whereby the body element and the further insulator form the energy break device.

47. An adapter for attaching a solar-shading bracket to a curtain walling mullion, the adapter comprising:
a body element for location on the curtain walling mullion and adapted to support the solar-shading bracket;
a mullion attachment for attaching the body element to the curtain walling mullion; and
a bracket attachment for attaching the solar-shading bracket to the body element,
wherein the solar-shading bracket includes an arm for supporting solar-shading louvers, which arm extends away from the curtain walling mullion when supported by the body element, and wherein at least part of the mullion attachment is positioned between the curtain walling mullion and the arm when the solar-shading bracket is attached to the curtain walling mullion.

48. An adapter according to claim 47, wherein the mullion attachment comprises a set of first fasteners for positioning through a set of corresponding first through-holes provided in the body element substantially perpendicularly with respect to a longitudinal extent of the curtain walling mullion.

49. An adapter according to claim 48, wherein the bracket attachment comprises a set of second fasteners for positioning through a set of corresponding second through-holes provided in the body element, the first and second through-holes being substantially perpendicular with respect to one another.

50. An adapter according to claim 49, wherein the body element comprises a longitudinal channel for receiving the solar-shading bracket and wherein the set of corresponding through-holes are transversely disposed relative to the longitudinal channel.

51. An adapter according to claim 47, further comprising an energy break device for providing heat insulation between the body element and the curtain walling mullion and also between the body element and the mullion attachment.

52. A solar-shading bracket and a curtain walling mullion assembly comprising:
an attachment for attaching the solar-shading bracket to the curtain walling mullion, wherein the assembly comprises an energy break device to provide heat insulation between the solar-shading bracket and the curtain walling mullion as well as between the attachment and the curtain walling mullion.

53. A solar-shading bracket and a curtain walling mullion assembly according to claim 52, wherein the energy break device comprises a first insulator provided between the solar-shading bracket and the curtain walling mullion and a second insulator provided between the attachment and the solar-shading bracket.

54. A solar-shading bracket and curtain walling mullion assembly according to claim 53, wherein the attachment comprises fasteners extending through the solar-shading bracket to the curtain walling mullion and the second insulator is provided between the fasteners and the solar shading bracket.

55. A method of retrofitting an energy break device between a curtain walling mullion and solar-shading bracket that are attached to one another by an attachment system, wherein the method comprises the steps of:
a) inserting a first insulator between the solar-shading bracket and the curtain walling mullion; and
b) inserting a second insulator between attachment system and the solar-shading bracket.
